(19) United States
(12) Patent Application Publication
(10) Pub. No.: US 2014/0031964 A1
(43) Pub. Date: Jan. 30, 2014

(54) METHOD AND SYSTEM FOR MANUFACTURING AN ARTICLE

(71) Applicants: Geoffrey Rajay Sidhu, Kelowna (CA); Abtar Shar Sidhu, Kelowna (CA)

(72) Inventors: Geoffrey Rajay Sidhu, Kelowna (CA); Abtar Shar Sidhu, Kelowna (CA)

(21) Appl. No.: 13/560,062

(22) Filed: Jul. 27, 2012

(51) Int. Cl. G05B 19/18

(52) U.S. Cl. 700/99

(57) ABSTRACT

A system and method for manufacturing an article comprising at a receiving station receiving an order for the manufacture of an article at a receiving station from a purchaser, determining a geographic location of the order, selecting at least one manufacturing location from a database containing a list of a plurality of manufacturing locations having computer numerical controlled machine tools and transmitting to the computer numerical controlled machine tools at the at least one manufacturing location computer readable instructions for forming the article. At the at least one manufacturing location, the computer readable instructions for forming the article are received, transmitted to a computer numerical controlled machine tool the article is provided to the purchaser.

### BACKGROUND OF THE INVENTION

1. Field of Invention

The present invention relates to manufacturing in general and in particular to a method and system for manufacturing articles over a distributed network.

2. Description of Related Art

Around the world many articles for consumer or industrial use and consumption are manufactured in one process or another. Frequently, such articles are manufactured at a location and then transported to the location of the consumer or a retail or wholesale location for purchase by the purchaser.

One difficulty that is commonly experienced during the manufacture and distribution of many articles is the cost associated with transporting the manufactured article to the point of sale or location desired by the consumer. Due to the costs of equipment, facilities and staffing, it has previously not been practical to establish and operate a large number of manufacturing plants so as to locate one such manufacturing plant in close proximity to the consumers.

One conventional manufacturing and distribution method has been to manufacture an article at a single location and shipping, by any known conventional means, of the manufactured article to the customers or retail locations. In such a method, the location of the manufacturing plant may be selected to be placed in a location where real estate, labor and raw material costs keep the manufacturing costs as low as possible. As set out above, such single location manufacturing has a relatively high cost of transportation and shipping to provide the manufactured article to the end consumer.

Another approach has been to build and operate multiple manufacturing facilities distributed across the geographic regions where the customers will likely be purchasing the articles. Such an approach, although reducing transportation costs, may result in increased costs to run such facilities. It will also be appreciated that having multiple production facilities may result in difficulties in ensuring that each facility is run at or near to its capacity which may thereby result in reduced efficiency.

### SUMMARY OF THE INVENTION

According to a first embodiment of the present invention there is disclosed a method for manufacturing an article comprising at a receiving station receiving an order for the manufacture of an article at a receiving station from a purchaser, determining a geographic location of the order, selecting at least one manufacturing location from a database containing a list of a plurality of manufacturing locations having computer numerical controlled machine tools and transmitting to the computer numerical controlled machine tools at the at least one manufacturing location computer readable instructions for forming the article. The method further comprises, at the at least one manufacturing location, receiving the computer readable instructions for forming the article, transmitting the computer readable instructions for forming the article to a computer numerical controlled machine tool and providing the article to the purchaser.

The computer numerical controlled machine tools are selected from the group consisting of a turret punch, a laser punch, a water plasma cutter, a laser combination turret punch, or a brake press.

According to a further embodiment of the present invention there is disclosed a system for manufacturing an article across a distributed network comprising a network connection for receiving an order for the manufacture of an article from a purchaser, a database containing a list of a plurality of manufacturing locations having computer numerical controlled machine tools, a processing circuit operable to receive the order, determine a geographic location of the order, select at least one manufacturing location from the database and a transmitter operable to transmit computer readable instructions for forming the article to the computer numerical controlled machine tools at the at least one manufacturing location.

According to a further embodiment of the present invention there is disclosed a method for manufacturing an article comprising receiving an order for the manufacture of an article at a receiving station, determining a geographic location of the order, selecting at least one manufacturing location from a database containing a list of a plurality of manufacturing locations having computer numerical controlled machine tools and transmitting to the computer numerical controlled machine tools at the at least one manufacturing location computer readable instructions for forming the article.

The plurality of manufacturing locations may each be independent of each other. The plurality of manufacturing locations may each be independent of the receiving station. The at least one manufacturing locations may be selected to be proximate to the geographic location of the order.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a distributed manufacturing network according to a first embodiment of the present invention.

FIG. 2 is a schematic view of the distributed manufacturing network of FIG. 1.

FIG. 3 is an illustration of a flowchart showing a process for manufacturing articles over a distributed network according to a further embodiment of the present invention.

FIG. 4 is a schematic view of a method of receiving an order at location and selecting a manufacturing location proximate to the order location.

### DETAILED DESCRIPTION

The present invention provides a method and system for receiving, processing and distributing the manufacturing of an article across a geographic region. The distributed manufacturing system of the present invention reduces the transportation distances necessary to distribute the finished manufactured article to a purchaser and may also provide greater flexibility to the manufacturing of the article.

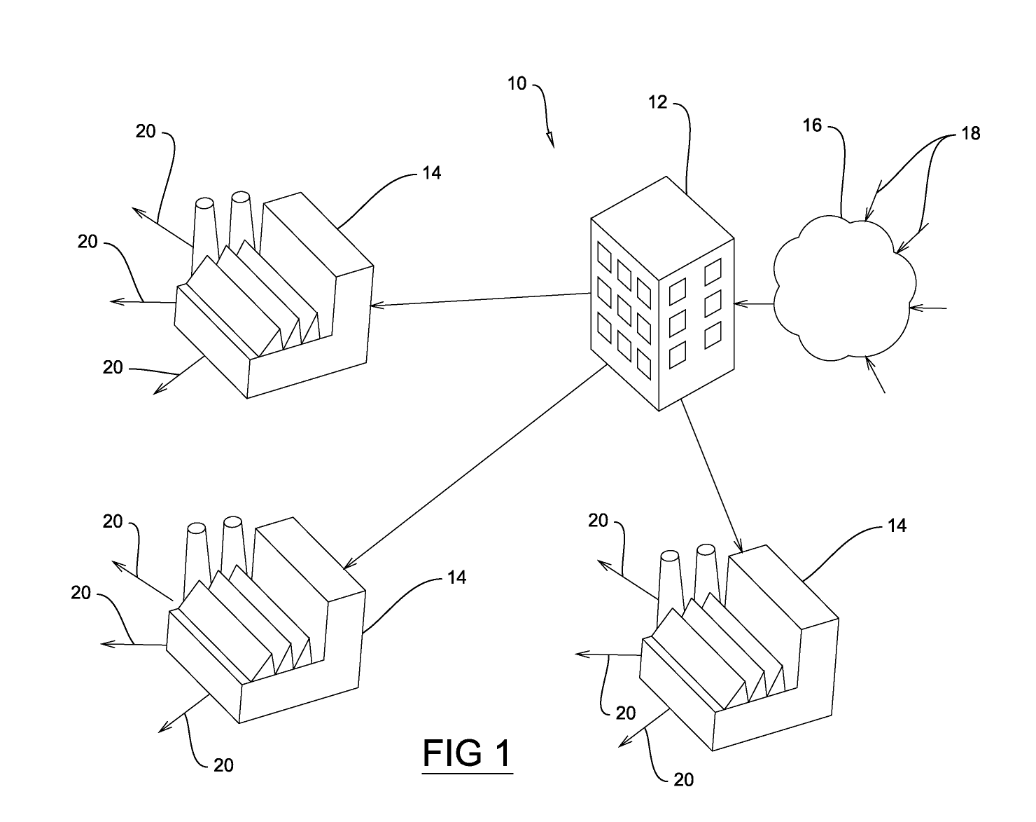

Referring to FIG. 1, a distributed manufacturing network according to a first embodiment of the invention is shown generally at 10. The network comprises a central receiving station 12 and at least one distributed manufacturing location 14. The central receiving station 12 is in communication with a communications network 16 to receive orders 18 transmitted thereto from a plurality of locations. The central receiving station 12 is adapted to process the orders 18, select a manufacturing location from a plurality manufacturing locations 20 and transmit manufacturing instructions to the selected manufacturing location as will be more fully described below. The selected manufacturing location will then manufacture the article for client delivery, transport or sale.

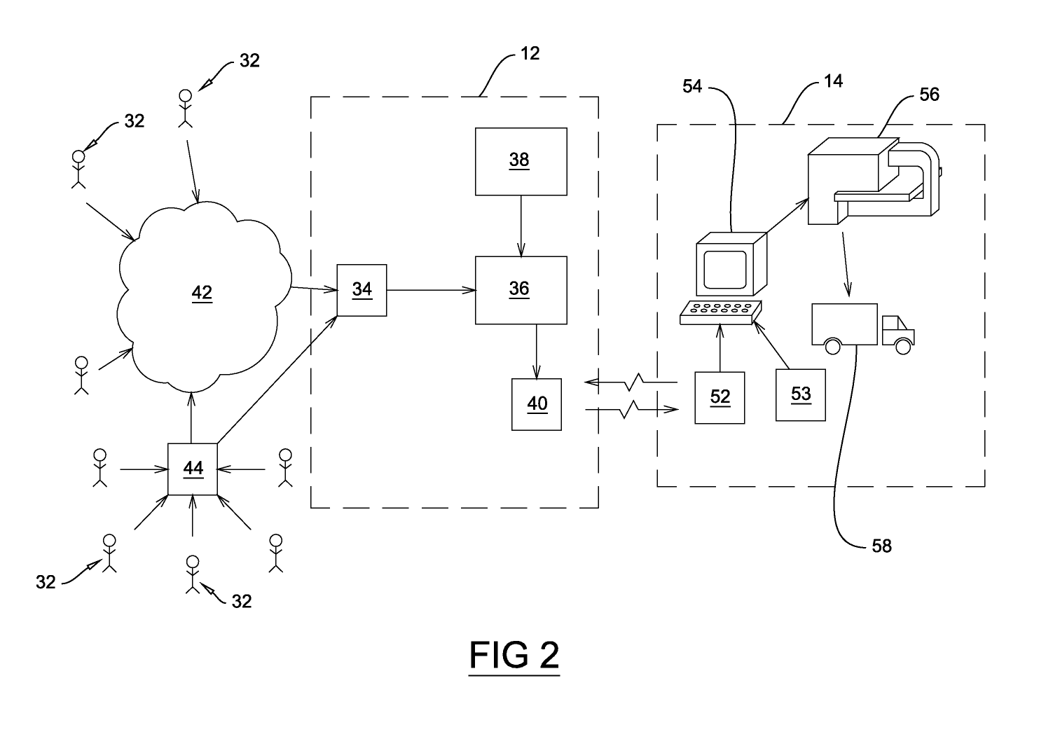

Turning now to FIG. 2, a schematic view of the distributed manufacturing system 10 is illustrated comprising a receiver station side 30 and a manufacturing location 50. The receiver station side 30 receives and processes the orders received from customers 32 and transmits manufacturing instructions to the manufacturing location 50. The manufacturing location 50 receives the manufacturing instructions from the receiver station side 30, manufactures the articles according to the manufacturing instructions and delivers, transports or otherwise makes the manufactured articles available to the purchaser 32.

The receiver station side 30 includes a network connector 34, such by way of non-limiting example, a modem, firewall or any other network adapter as will be understood and a transaction processing circuit 36. The processing circuit 36 may include a microprocessor, or more generally, in this specification, including the claims, the term “processing circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processing circuits will be apparent to those ordinarily skilled in the art upon review of this specification, and substitution of any such other types of processing circuits is considered not to depart from the scope of the present invention as defined by the claims appended hereto. It will also be appreciated that the functions of the processing circuit may, in some embodiments be performed by a person.

The receiver station side 30 includes a manufacturer database 38 in communication with the processing circuit 36 which may be stored on a common or separate memory device which in this embodiment include a hard disk drive. Alternatively, however, any other suitable memory device or mechanism, such as random access memory, memory storage devices, optical storage devices, magnetic media, floppy disks, magnetic tapes and drives, hard drives, SIMMs, SDRAM, DIMMs, RDRAM, DDR RAM, SODIMMS, erasable programmable read-only memories (EPROMs), electrically erasable programmable read-only memories (EEPROMs), FLASH memory, compact disks, DVDs, and/or the like. In accordance with some embodiments, memory devices may include one or more disk drives, flash drives, databases, local cache memories, processor cache memories, relational databases, flat databases, and/or the like. In addition, those of ordinary skill in the art will appreciate many additional devices and techniques for storing information can be used as memory devices. The manufacturer database may also include codes assigned to each manufacturing location so as to instruct each manufacturing location to apply their code to any articles manufactured at that location to permit tracking and assist quality control at later dates.

The receiver station side 30 is in communication with purchasers via network connections 34, such as, by way of non-limiting example internet connections, telephone systems, fax machines or the like. The purchasers may access the network connection 34 via a distributed network 42, such as a telephone system or the internet generally indicated at 42. Optionally, a data processing center 44, such as, by way of non-limiting example, a call center, sales office, server or the like may be utilized to receive, process and transmit orders to the receiver station side 30 either directly or through the distributed network 42.

The receiver station side also includes a manufacturing network connection 40 in communication with the at least one manufacturing locations as will be more fully described below. The manufacturing network connection 40 transmits the manufacturing instructions to the manufacturing location as will be more fully described below.

The manufacturing location 50 comprises a manufacturing location selected to manufacture and provide the manufactured article to the purchaser. Although only one manufacturing location 50 is illustrated in FIG. 2, it will be appreciated that many manufacturing locations may be utilized as illustrated in FIG. 1 wherein the processing circuit 36 selects one or more manufacturing location corresponding most closely to the location of the purchaser. The manufacturing location 50 includes a network connection 52, a tool control computer 54 and a manufacturing tool 56. The network connection 52 receives the instructions from the receiver station side 30 and transmits tool control computer 54 which controls the operation of the manufacturing tool 56 to manufacture the article and may be any known type, such as, by way of non-limiting example internet connections, telephone systems, fax machines or the like. The transmissions between the manufacturing network connection 40 and the network connection 52 may be of any conventional type, such as, wired, wireless, telephone, fax, internet or the like. It will also be appreciated that the functions of the network connection 52 may, in some embodiments be performed by a person inputting the instructions received from the receiver station side 30 to the tool control computer 54.

The manufacturing tool 56 may be of any conventionally known computer numerically controlled machine tools, such as, by way of non-limiting example, a turret punch, a laser punch, a water plasma cutter, a laser combination turret punch a mill or a lathe. In other embodiments, more than one manufacturing processes and numerically computer controlled machine tools may also be utilized, such as, by way of non-limiting example, a brake press. In particular, the manufacturing location 50 may include a turret punch, laser punch or laser combination turret punch to form a blank, as they are commonly known for the article from sheet or roll metal and thereafter a computer numerically controlled brake press may be utilized to bend or otherwise form the blanks into the finished article. Optionally, one or more of the numerically computer machine tools may also be operable to stamp, punch, engrave, or otherwise apply data to one or more surfaces of the finished article, including, without limitation, patent numbers, manufacturing location, ordering company, part numbers or trade marks or trade names. The instructions provided by the receiver station side 30 to the manufacturing computer 54 may comprise a specification, computer assisted drafting and manufacturing drawings so as to provide adequate instructions to the manufacturing tool to form the article with little to no additional input from a user. After the article has been manufactured, the manufacturing location 50 may provide the finished article to the purchaser 32 by delivery, transport or sale according to any known means as indicated generally at 58.

When the manufacturing location receives the manufacturing instructions, the tool control computer 54 may interpret, or otherwise transform the manufacturing instructions into a format which is usable by the manufacturing tool 56. Such formats may be unique for each manufacturing location and therefore, the manufacturing instructions will be transmitted in such a format so as to be convertible by each of the manufacturing locations. Optionally, the manufacturing location 50 may include a manufacturing database 53 operable to store the manufacturing instructions for each article or variation thereof, such that a plurality of variations of the article may be produced by retrieving such unique manufacturing instructions for each variation from the manufacturing database 53. The manufacturing database 53 may be of any common memory type as described above. In particular, according to one embodiment of the present invention, the manufacturing instructions may comprise computer readable drawings or CAD files for the manufactured article. At each manufacturing location 50, the tool control computer 54 may convert the computer readable drawings into instructions adapted to be followed for the particular manufacturing tool 56 at that location. Thereafter such instructions will be stored in the manufacturing database.

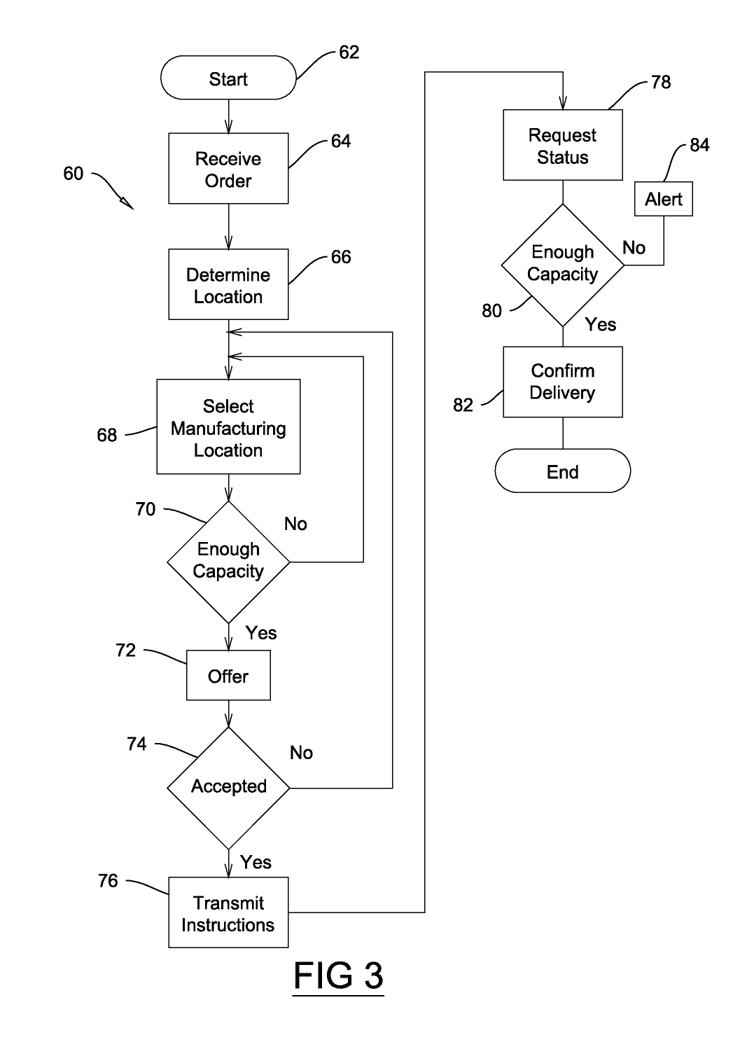

Turning to FIG. 3, a flow diagram of the transaction process performed by the receiver station side 30 is illustrated generally at 60. The process begins at step 62 with an initialized receiver station side 30. An order is received from a purchaser 32 at step 64 as set out above. The receiver station side 30 then determines the location of the purchaser at step 66. The receiver station side 30 may determine the geographic location of the purchaser via global positioning, requiring an input of the location or any other conventionally known means. Once the geographic location of the order has been determined, the processing circuit looks up an appropriate manufacturing location from the database 38 in step 68 and verifies that the manufacturing location has a sufficient capacity to manufacture the article in step 70. If the manufacturing location does not have sufficient capacity, the processing circuit looks up an additional manufacturing location in step 68 again. The processing circuit 36 then offers the order to each manufacturing location for acceptance at step 74. If the offer is not accepted at 74, the processing circuit looks up another manufacturing location at 68 again. Once the orders have been accepted, the processing circuit transmits the manufacturing instructions to the manufacturing location at step 76. After the manufacturing instructions have been transmitted to the manufacturing location, the receiver station side 30 may poll or inquire with the manufacturing location 50 as to the status of the order at step 78. The receiver station side 30 then checks the reply of the status at step 80 and compares it to the anticipated schedule for such an article. If the current order is on schedule, the receiver station side 30 awaits confirmation or delivery of the order at step 82. If the current order is not on schedule, the receiver station side 30 provides an alert to the processing circuit 36 or a user which may then determine if all or a part of the order should be sent to another manufacturing location in step 68 or if other corrective action is necessary. Steps 78 through 84 may be performed at any time interval after the transmission of the manufacturing instructions at step 76 and may also be performed more than one time during the manufacturing of the article. Optionally, the processing circuit may thereafter transmit payment to the manufacturing location. Furthermore, the receiver station side 30 may optionally request that a sample, photographs or other evidence of the finished article be sent to the receiver station side 30 for the receiver station side 30 to perform quality assessments thereon.

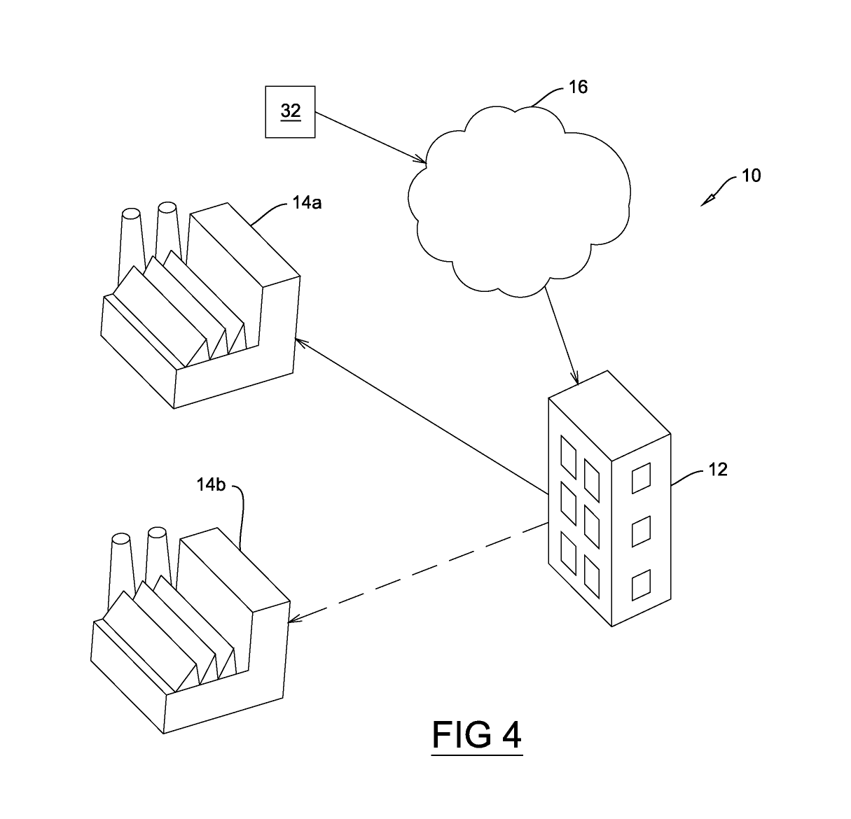

Turning to FIG. 4, a schematic of the system of the present invention is illustrated showing the receiver station side 30 selecting a manufacturing location 14a which is determined to be closest in geographic proximity to the order received from a purchaser 32. Optionally, the receiver station side 30 may also divide the order between more than one manufacturing location based upon the manufacturing capacity of the manufacturing locations available such that a second closes manufacturing location 14b is also selected to manufacture a portion of the order.

In operation, the manufacturing instructions which are sent to each manufacturing location will include the computer readable instructions which will ensure that each manufacturing tool will be manufactured to the close specifications thereof. According to some embodiments of the present invention, the manufacturing instructions will be exact specifications for the dimensions, materials, tolerances and other finishing details of the manufactured article. In such a way, it will be observed that the manufactured article produced by each manufacturing location will be nearly or exactly identical to each other. The manufacturing instructions will also include specifications of the tools that are to be used for each manufacturing step and close specifications of the raw materials that are to be used in forming the article. It will be appreciated that the manufacturing locations which are included in the database 38 will be selected to only be those manufacturing locations which have the computer numerically controlled tools which fit the specifications of the article to be manufactured.

Optionally, each of the manufacturing locations 14 may be independent of the receiver station side 30. In the present specification, independent is used to denote that each manufacturing location 14 is under separate control, management and operation from the receiver station side 30 and may optionally include each manufacturing location 14 being owned separately from the receiver station side 30. Thus it will be observed that in such embodiments, the receiver station side 30 will not include any overhead for owning and operating the manufacturing locations and will be able to provide maximum flexibility in the manufacturing of the article without sacrificing quality or consistency.

While specific embodiments of the invention have been described and illustrated, such embodiments should be considered illustrative of the invention only and not as limiting the invention as construed in accordance with the accompanying claims.

What is claimed is:

1. A method for manufacturing an article comprising:
at a receiving station,
receiving an order for the manufacture of an article at a receiving station from a purchaser;
determining a geographic location of said order;
selecting at least one manufacturing location from a database containing a list of a plurality of manufacturing locations having computer numerical controlled machine tools; and
transmitting to said computer numerical controlled machine tools at said at least one manufacturing location computer readable instructions for forming said article; and
at said at least one manufacturing location,
receiving said computer readable instructions for forming said article;
transmitting said computer readable instructions for forming said article to a computer numerical controlled machine tools; and
providing said article to said purchaser.

2. The method of claim 1 wherein said computer numerical controlled machine tools are selected from the group consisting of a turret punch, a laser punch, a laser combination turret punch, or a brake press.

3. A receiving station system for manufacturing an article comprising:
a network connection for receiving an order for the manufacture of an article from a purchaser;
a database containing a list of a plurality of manufacturing locations having computer numerical controlled machine tools;
a processing circuit operable to receive said order, determine a geographic location of said order, select at least one manufacturing location from said database; and
a transmitter operable to transmit computer readable instructions for forming said article to said computer numerical controlled machine tools at said at least one manufacturing location.

3. A method for manufacturing an article comprising:
receiving an order for the manufacture of an article at a receiving station;
determining a geographic location of said order;
selecting at least one manufacturing location from a database containing a list of a plurality of manufacturing locations having computer numerical controlled machine tools; and
transmitting to said computer numerical controlled machine tools at said at least one manufacturing location computer readable instructions for forming said article.

4. The method of claim 3 wherein said plurality of manufacturing locations are each independent of each other.

5. The method of claim 3 wherein said plurality of manufacturing locations are each independent of said receiving station.

6. The method of claim 3 wherein said at least one manufacturing locations are selected to be proximate to the geographic location of said order.
